(19) United States
(12) Patent Application Publication
(10) Pub. No.: US 2004/0070363 A1
(43) Pub. Date: Apr. 15, 2004

(54) INTEGRATED INDUCTION STARTER/GENERATOR SYSTEM WITH HYBRID CONTROL FOR HIGH SPEED GENERATION AND IDLE SPEED SMOOTHING

(76) Inventors: David J. Bardsley, Manchester, MI (US); Youqing Xiang, Canton, MI (US)

Correspondence Address: BRINKS HOFER GILSON & LIONE, P.O. BOX 10395, CHICAGO, IL, 60611, US

(21) Appl. No.: 10/268,510

(22) Filed: Oct. 10, 2002

(51) Int. Cl. H02P 1/24

(52) U.S. Cl. 318/727

(57) ABSTRACT

The present invention includes an induction motor and a system for controlling the induction motor including a battery providing a DC voltage and an inverter coupled to the induction motor and the battery, wherein the inverter is adapted to drive the induction motor from the battery. A motor controller is adapted to calculate a flux current and a slip frequency in response to an induction motor speed. The motor controller is further adapted to operate in one of a current control mode or a slip control mode. The motor controller is adapted to cause the slip frequency to increase by a slip decremental in a transition phase from the current control mode to the slip control mode, and further adapted to cause the slip frequency to increase by a slip incremental in a transition phase from the slip control mode to the current control mode.

### TECHNICAL FIELD OF THE INVENTION

The present invention relates to an induction motor control system, and in particular, the present invention includes a hybrid control system for an induction motor adapted for high speed generation and idle speed smoothing.

### BACKGROUND OF THE INVENTION

Conventional field oriented (FO) induction machine drives are being actively pursued in the automotive field as a high-power generation means. Specifically, it is of great interest to replace the common DC starter and claw-pole alternator of an internal combustion engine with an integrated starter/generator. The integrated starter/generator induction machine is electronically controlled and optimized to increase fuel economy and reduce vehicle emissions in both conventional and hybrid vehicles.

An induction machine for automotive applications is usually required to generate at least 2-4 kW DC electric power with an internal combustion engine speed variation from 800 to 6000 rpm. Although induction machines are capable of variable-speed operation, the challenge presented is to meet all of the torque and power requirements for such a wide speed range, while simultaneously combining the motoring function of the induction machine with a starter/generator function.

In order to minimize the power train modification, the induction machine is located in the space formerly occupied by the claw-pole alternator. In a typical configuration, the induction machine is coupled to the internal combustion engine through a belt. In order to amplify the torque output of the induction machine, the gear ratio between the induction machine and the internal combustion engine is preferably between 2 and 2.5.

Given the aforementioned torque output and gear ratio, the induction machine will be required to operate at speeds up to 15,000 rpm. The fundamental frequency of the induction machine current is generally about 1 kHz. In order to save the costs inherent in an already complex machine, most induction machines use relatively low-cost current sensors. However, at very high speeds, the traditional current sensors may not be sufficient to maintain control over the induction machine. Similarly, because the pulse width modulation (PWM) frequency is generally on the order of 10 kHz, the inverter loss reduction can become sluggish. The foregoing design parameters common to a conventional current feedback control are not suitable for high-speed operation of an induction machine.

There are other features of an induction motor that have not been successfully applied to the automotive field. For example, during idle speed operation, the speed of the internal combustion engine crank is subject to a great deal of fluctuation and vibration. Although it is desirable to smooth-out the operation of the vehicle in an idle state, conventionally-controlled induction machines have failed to replace the commonly-used flywheel for this purpose. A flywheel, however, possesses the dual limitations of increased weight and delayed dynamic response to torque and speed demands. The application of induction machines in this capacity has been delayed due to the power-requirements necessary for its control

Due to limited BUS voltage, a typical induction machine is designed to have limited power capability in the high-speed operating region. The voltage shortage is compounded by the fact that the battery that supplies current to the induction machine does not always accept full charge. It is understood that the conventional current-loop control system for an induction machine requires up to 20% of the BUS voltage for current regulation, further hampering the controller's ability to utilize the available BUS voltage for high-speed operation.

Even an induction machine that overcomes the foregoing limitations will likely suffer from an asymmetric instability. It has been generally assumed that, based upon steady-state models, the motoring and generating modes of an induction machine were dynamically symmetrical. Accordingly, it was assumed that in the generating mode an induction machine should be able to achieve comparable performance to that in a motoring mode.

However, it is now understood that at high-speed generation, the induction machine may exhibit instability, meaning that the controller is unable to regulate both the iq and id current loops. This instability is not present in the motoring mode, implying that for an identical rotor speed and slip speed, the performance of an induction machine will be asymmetrical in the motoring and generating modes. The dynamic asymmetry becomes more prominent at high speeds.

### SUMMARY OF THE INVENTION

Accordingly, the present invention provides a hybrid-control scheme for an induction machine that includes an induction motor, a battery providing a DC voltage, and a voltage inverter coupled to the induction motor and the battery for driving the induction motor from the battery. The present invention also includes a motor controller adapted to calculate a flux current and a slip frequency in response to the induction motor speed. The motor controller is also adapted to operate in one of a current control mode or a slip control mode.

The motor controller of the present invention transitions between the current control mode and the slip control mode through a simple algorithm. Specifically, the motor controller causes the slip frequency to increase by a slip decremental in the transition from the current control mode to the slip control mode, while conversely causing the slip frequency to increase by a slip incremental in the transition from the slip control mode to the current control mode.

The motor controller of the present invention is also adapted to receive and respond to control signals from a power train controller. In particular, the power train controller transmits signals indicative of a torque demand or a motor speed demand, to which the motor controller responds by operating in one of a torque control mode or a speed control mode. The torque control mode is particularly useful in engine starting, torque boost applications, and charging the battery coupled to the induction machine. The speed control mode is utilized when the internal combustion engine is idling, thus permitting the battery to be charged while smoothing the idle speed fluctuations.

### BRIEF DESCRIPTION OF THE DRAWINGS

FIG. 1 is a block diagram depicting the integrated starter/generator with an induction machine and associated control elements.

FIG. 2 is a control scheme of the prior art means for indirect field-orientation control of an induction machine.

FIG. 3 is a control scheme in accordance with the preferred embodiment of the present invention having torque control, speed control, and a hybrid slip-loop and current-loop control.

FIG. 4 is a flowchart showing the transition from the current control mode to the slip control mode.

FIG. 5 is a flowchart showing the transition from the slip control mode to the current control mode.

FIG. 6 is a series of graphical representations of experimental data indicative of the operation of the present invention.

### DETAILED DESCRIPTION OF THE INVENTION

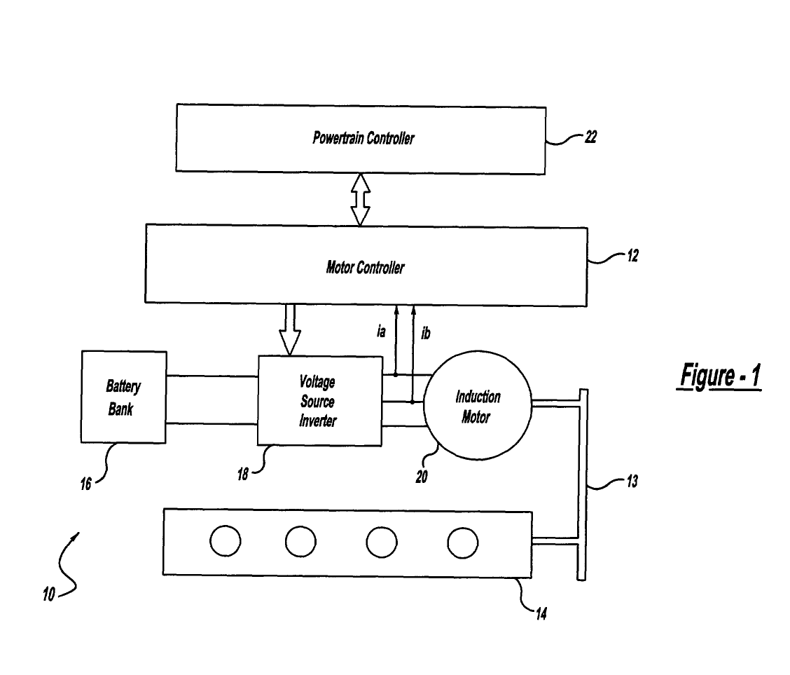

In accordance with its preferred embodiment, the induction machine system 10 of the present invention generally comprises the components depicted in FIG. 1. The induction machine system 10 includes an induction motor 20 coupled to an internal combustion engine 14 via a belt drive system 13. The induction motor 20 is coupled to a voltage source inverter 18, both of which receive electrical current from a battery bank 16.

The voltage source inverter 18 transmits current from the induction motor 20 to the battery bank 16 when the induction motor 20 is in the generating mode; and when the induction motor 20 is in the motoring mode, the voltage source inverter 18 transmits current from the battery bank 16 to the induction motor 20.

The voltage source inverter 18 and the induction motor 20 are controlled locally by the motor controller 12, which in turn receives high-level commands from the power train controller 22. In particular, the power train controller 22 generates and transmits signals indicative of a requested torque command or a requested speed command for operation in a torque control mode or a speed control mode, respectively. The particulars of the control scheme implemented by the motor controller 12 are discussed in more detail herein.

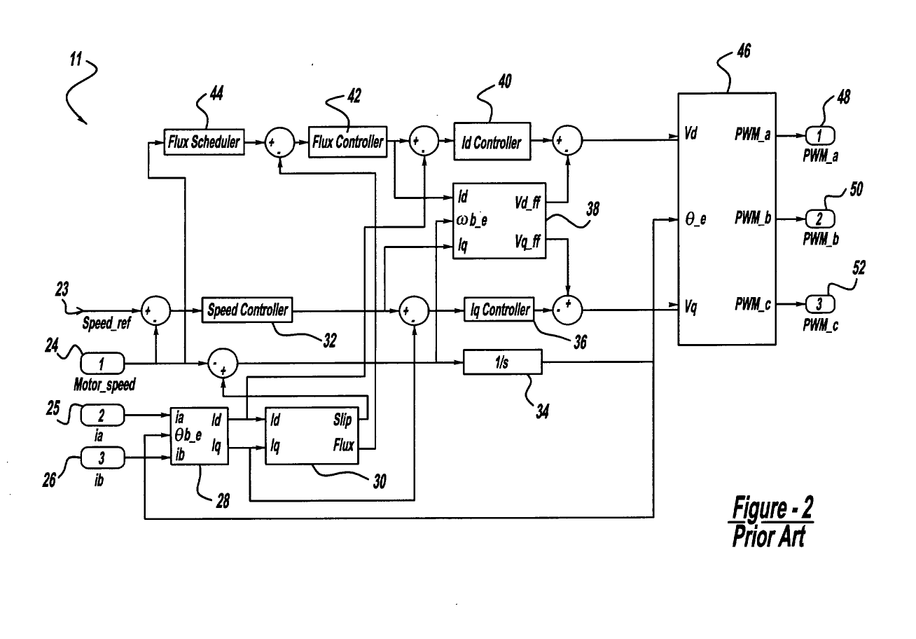

A motor controller 11 typical of the prior art is depicted schematically in FIG. 2. This motor controller 11 is characterized in that it detects two input currents, ia 25 and ib 26, and transforms these two input currents into regulated currents Id and Iq via a Park Transformation 28. Using a flux model of induction machines, the flux and slip are calculated from Id and Iq at 30. Additionally, the motor controller 11 is adapted to receive inputs indicative of the motor speed 24 and a reference rotor speed 23.

The motor controller 11 is generally comprised of two channels, a first channel for flux control and a second channel for speed control. The flux control channel includes a flux scheduler 44 for generating a reference flux. The reference flux is calculated based upon the motor speed, which is commonly calculated from the rotor position signal in order to take full advantage of the induction machine under the DC-BUS voltage limitations. The reference flux is compared to the calculated flux, and the difference is passed through the flux controller 42 to generate the d-axis current. The Id controller 40 regulates the difference between the reference and feedback d-axis current. The final d-axis voltage command 46 is the summation of the output from the Id controller 40 and the voltage feedforward 38.

The speed control channel includes a speed controller 32, an integrator 34, and an Iq controller 36. Analogous in structure to the flux control channel, the speed controller 32 generates the q-axis current by processing the difference between the reference speed 23 and the measured speed. The Iq controller 36 regulates the difference between the reference and feedback q-axis current. The final q-axis voltage command 46 is the summation of the output from the Iq controller 36 and the voltage feedforward 38.

In the final phase, the q-axis and d-axis voltage commands 46 are converted into pulse width modulated (PWM) three-phase variables 46. The resultant signals, PMW_a 48, PMW_b 50, and PMW_c 52 actuate the voltage source inverter 18. This form of motor controller 11 has shown problems as described above.

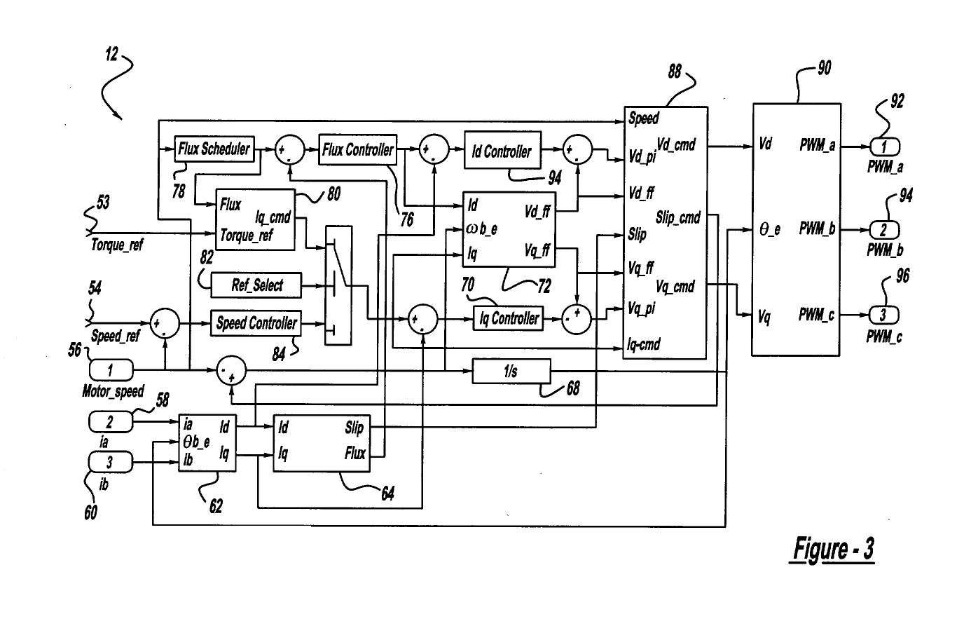

FIG. 3 is illustrative of a preferred embodiment of the motor controller 12 of the present invention. The present motor controller 12 is characterized in that it detects two input currents, ia 58 and ib 60, and transforms these two input currents into regulated currents Id and Iq via a Park Transformation 62. Using the flux model of induction machines, the flux and slip are calculated from Id and Iq 64. Additionally, the motor controller 12 is adapted to receive inputs indicative of the motor speed 56, a reference torque command 53, and a reference rotor speed 23.

The present motor controller 12 also comprises in part a flux control channel and a speed control channel. The flux control channel includes a flux scheduler 78 for generating a reference flux. The reference flux is compared to the calculated flux, and the difference is passed through the flux controller 76 to generate the d-axis current. The Id controller 74 regulates the difference between the reference and feedback d-axis current. The final d-axis voltage command 88 is the summation of the output from the Id controller 74 and the voltage feedforward 72.

The speed control channel includes a speed controller 84, an integrator 68, and an Iq controller 70. Analogous in structure to the flux control channel, the speed controller 84 generates the q-axis current by processing the difference between the reference speed 54 and the measured speed. The Iq controller 70 regulates the difference between the reference and feedback q-axis current. The final q-axis voltage command 88 is the summation of the output from the Iq controller 70 and the voltage feedforward 72.

The motor controller 12 of the present invention is also characterized in that it is operable in a torque control mode. The torque reference command 53 is transmitted to an Iq torque mapping control 80. The Iq torque mapping control 80 may operate through a look up table method, such that for each torque reference command 53, there is a corresponding Iq command calculated by the Iq torque mapping control 80.

The torque control mode is employed for engine starting, torque boost, and battery charging. The torque reference command 53 is determined by the power train controller 22 and transmitted to the motor controller 12. The Iq torque mapping 80 is selected at the reference select 82 terminal, which selects between the torque control mode and the speed control mode via a switch 86. The speed control mode is employed during engine idling, in particular for induction machine systems having a diesel engine.

A second feature of the present motor controller 12 is the mode transition terminal 88. As noted, the induction motor 20 of the present invention operates in a hybrid control including a slip control mode and a current control mode. The mode transition terminal 88 functions to determine, select, and transition between each of the foregoing modes. In doing so, the mode transition terminal 88 receives inputs indicative of the motor speed 56, Vd_pi, Vd_ff, Slip, Vq_ff, and Vq_pi, which are transformed into the known outputs Vd_cmd, Slip_cmd, and Vq_cmd.

In the final control phase, the q-axis and d-axis voltage commands determined at the mode transition terminal 88 are converted into pulse width modulated (PWM) three-phase variables 90. The resultant signals, PMW_a 92, PMW_b 94, and PMW_c 96 actuate the voltage source inverter 18. The details of the mode transition between the slip control mode and the current control mode are discussed below.

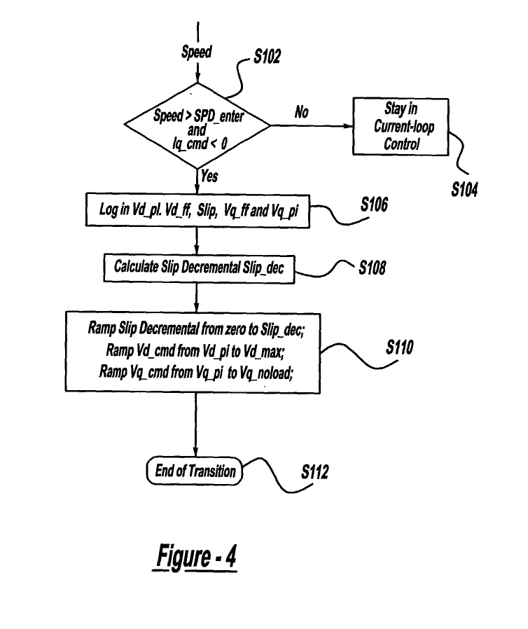

FIG. 4 is a flow chart illustrating the transition from the current control mode to the slip control mode. The motor speed 56 is a measured quantity that is compared to a predetermined SPD_enter value in step S102. If the SPD_enter value is not less than the motor speed, or if the Iq_cmd value is non-negative, then the motor controller 12 maintains the current control mode as shown in step S104. If the SPD_enter value is less than the detected motor speed and the Iq_cmd value is less than zero, then the motor controller 12 progresses to step S 106, in which the input values shown in the mode transition terminal 88 are recognized by the motor controller 12. The input values include Vd_pi, Vd_ff, Slip, Vq_ff, and Vq_pi. In step S108, the motor controller 12 calculates the slip decremental Slip_dec, as given by the following equation:

$$Slip\_dec = ( 1 - abs ( \frac{Vd\_pi}{Vd\_max} ) ) * Slip \qquad ( 1 )$$

where Vd_max is a predetermined constant.

In step S110, the motor controller 12 gradually transitions into the slip control mode by increasing the slip decremental from zero to Slip_dec. Correspondingly, the Vd_cmd is ramped from Vd_pi to Vd_max, and the Vq_cmd is ramped from Vq_pi to Vq_noload, a predetermined constant. The transition from the current control mode to the slip control mode is then completed in step S112.

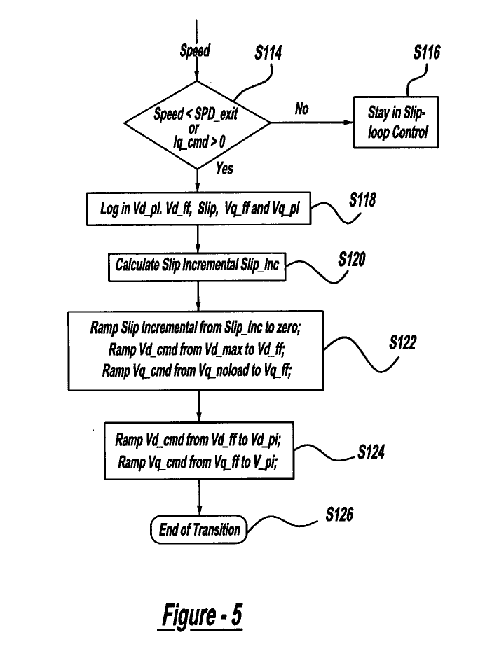

FIG. 5 is a flow chart illustrating the transition from the slip control mode to the current control mode. The motor speed 56 is a measured quantity that is compared to a predetermined SPD_exit value in step S114. If the SPD_exit value is less than the motor speed and the Iq_cmd value is not positive, then the motor controller 12 maintains the slip control mode as shown in step S116. If the SPD_exit value is greater than the detected motor speed or the Iq_cmd value becomes positive, then the motor controller 12 progresses to step S118, in which the input values shown in the mode transition terminal 88 are recognized by the motor controller 12. As before, the input values include Vd_pi, Vd_ff, Slip, Vq_ff, and Vq_pi. In step S120, the motor controller 12 calculates the slip incremental Slip_inc, as given by the following equation:

$$Slip\_inc = ( 1 - abs ( \frac{Vd\_ff}{Vd\_max} ) ) * Slip \qquad ( 2 )$$

where Vd_max is a predetermined constant.

In step S122, the motor controller 12 gradually transitions from the slip control mode by increasing the slip decremental from Slip_inc to zero. Correspondingly, the Vd_cmd is ramped from Vd_max to Vd_ff, and the Vq_cmd is ramped from Vq_noload to Vq_ff, a predetermined constant. In step S 124, the Vd_cmd is ramped from Vd_ff to Vd_pi, and the Vq_cmd is ramped from Vq_ff to Vq_pi. The transition from the slip control mode to the current control mode is then completed in step S126.

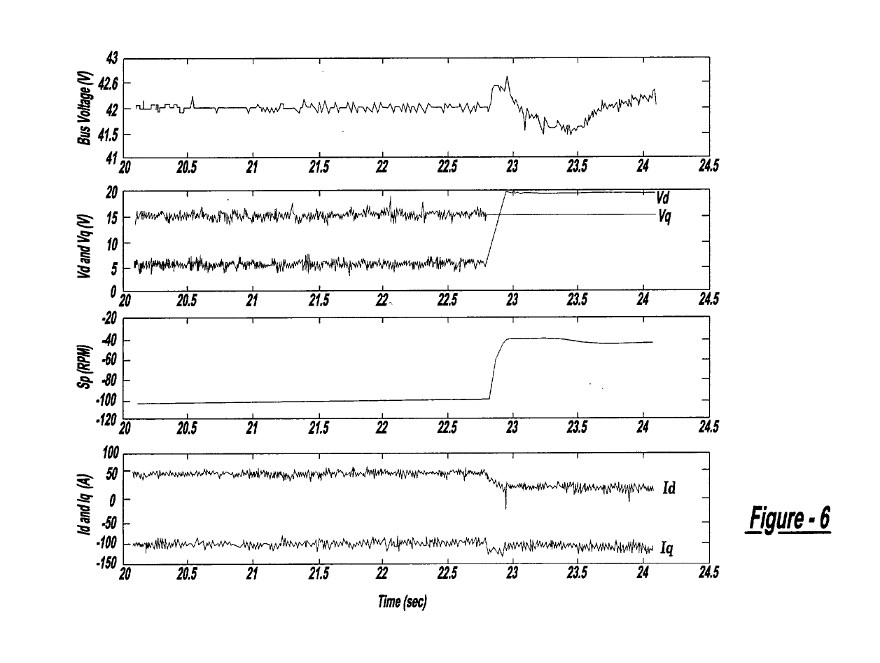

As evidenced by the data displayed in FIG. 6, the transition between the current control mode and the slip control mode are smooth, stable, and fast. The variation and stabilization of the BUS voltage, Vd and Vq, Slip, and Id and Iq are shown respectively over a short amount of time. Consequently, the induction machine of the present invention provides a simple and cost-effective solution to the problems associated with the prior art. Notably, utilization of a hybrid control scheme with a current control mode and a slip control mode makes efficient use of the BUS voltage limitations, while simultaneously regulating the aforementioned instabilities present at high speed operation.

As described, the present invention consists of a system for controlling the high-speed usage of an induction machine for particular application in an automobile. Nevertheless, it should be apparent to those skilled in the art that the above-described embodiments are merely illustrative of but a few of the many possible specific embodiments of the present invention. Numerous and various other arrangements can be readily devised by those skilled in the art without departing from the spirit and scope of the invention as defined in the following claims.

1. An induction machine system comprising:
an induction motor;
a battery providing a DC voltage;
an inverter coupled to the induction motor and the battery, the inverter adapted to drive the induction motor from the battery; and
a motor controller adapted to calculate a flux current and a slip frequency in response to an induction motor speed, the motor controller further adapted to operate in one of a current control mode or a slip control mode, the motor controller further adapted to cause the slip frequency to increase by a slip decremental in a transition phase from the current control mode to the slip control mode, and further adapted to cause the slip frequency to increase by a slip incremental in a transition phase from the slip control mode to the current control mode.

2. The induction machine system of claim 1 further comprising a power train controller, the power train controller adapted to control the induction machine in a speed control mode wherein the power train controller calculates a requested speed input.

3. The induction machine system of claim 2 wherein the power train controller is adapted to control the induction machine in a torque control mode wherein the power train controller calculates a requested torque input.

4. The induction machine system of claim 1 wherein the motor controller is further adapted to operate in a torque control mode wherein in response to a requested torque input, the motor controller regulates a q-axis current.

5. The induction machine system of claim 1 wherein the motor controller is further adapted to respond to a requested speed input.

6. The induction machine system of claim 1 wherein in response to a rotor speed being greater than an enter speed, the motor controller transitions from the current control mode to the slip control mode.

7. The induction machine system of claim 6 wherein while in the current control mode, in response to the rotor speed being less than the enter speed, the motor controller maintains the current control mode.

8. The induction machine system of claim 1 wherein in response to the rotor speed being less than an exit speed, the motor controller transitions from the slip control mode to the current control mode.

9. The induction machine system of claim 8 wherein while in the slip control mode, in response to the rotor speed being greater than the exit, the motor controller maintains the slip control mode.
